(19) United States
(12) Patent Application Publication
(10) Pub. No.: US 2014/0123198 A1
(43) Pub. Date: May 1, 2014

(54) BROADCASTING RECEIVING APPARATUS AND METHOD

(71) Applicant: Kabushiki Kaisha Toshiba, Tokyo (JP)

(72) Inventors: Makoto Sato, Tokyo (JP); Michihiro Fukushima, Tokyo (JP)

(73) Assignee: Kabushiki Kaisha Toshiba, Tokyo (JP)

(21) Appl. No.: 13/894,689

(22) Filed: May 15, 2013

(30) Foreign Application Priority Data
Oct. 31, 2012 (JP) 2012-240717

(51) Int. Cl. H04N 21/45

(52) U.S. Cl. CPC H04N 21/4516
USPC 725/110

(57) ABSTRACT

According to one embodiment, a broadcasting receiving method includes: informing a server storing content data of data related to a display size of a screen and acquiring the content data according to the display size; generating display data obtained by combining the contents data with a moving image, with a display size based on layout information included in the acquired contents data; and performing image processing on the display data for being displayed on the screen to output the display data on which the image processing is performed, wherein when a ratio of a display area of the moving image with respect to the screen is a predetermined value or more based on the display size of the moving image based on the layout information, downscaling an image based on the content data to generate display data obtained by combining the moving image with the downscaled image.

### CROSS-REFERENCE TO RELATED APPLICATIONS

This application is based upon and claims the benefit of priority from Japanese Patent Application No. 2012-240717, filed Oct. 31, 2012, the entire contents of which are incorporated herein by reference.

### FIELD

Embodiments described herein relate generally to a broadcasting receiving apparatus and method.

### BACKGROUND

Conventionally, communication-broadcasting integrated services such as the Hybridcast have been known, in which broadcasting and communications via a communications network such as the Internet are merged. In the communication-broadcasting integrated services, moving images distributed by broadcasting and content written in the HyperText Markup Language (HTML) or the like are combined by a general-purpose application processor (AP) in a broadcasting receiving apparatus to generate display data, which is improved in image quality by a back end processor (BEP) specializing in image processing and displayed on a display panel.

In recent years, display panels with 4096×2160 pixels (hereinafter referred to as 4K) or the like having higher resolution than 2048×1080 pixels (hereinafter referred to as 2K) have been developed, and HTML contents according to the 4K display are being distributed. However, because of the limitations of transmission bandwidth or the like, moving images are currently often distributed with 2K. When content of the communication-broadcasting integrated services is displayed on a 4K display panel, therefore, the scaling of a 2K moving image is performed on the general-purpose AP side, thereby degrading the image quality of the moving image in some cases.

For example, in the case of combination with 4K HTML content in which a 2K moving image is displayed on nearly the entire screen of a 4K display panel, the scaling of the 2K moving image to 4K is required to be performed on the AP side that generates display data by combining the moving image and the HTML content before the combination. This makes the BEP specializing in image processing unable to be utilized for the scaling of the 2K image, thereby degrading the image quality of the moving image in some cases.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram illustrating the configuration of a receiving apparatus according to a first embodiment;

FIG. 2 is an exemplary block diagram illustrating a modification of the receiving apparatus;

FIG. 3 is an exemplary flowchart illustrating an example of the operation of the receiving apparatus in the first embodiment;

FIG. 4 is an exemplary schematic view exemplifying a layout of display data by HTML content;

FIG. 5 is an exemplary schematic view exemplifying an operational outline of the receiving apparatuses in the first embodiment;

FIG. 6 is an exemplary schematic view exemplifying an operational outline of the receiving apparatuses in the first embodiment;

FIG. 7 is an exemplary flowchart illustrating a modification of the operation of the receiving apparatuses in the first embodiment; and

FIG. 8 is an exemplary schematic view exemplifying an operational outline of receiving apparatuses according to a second embodiment.

### DETAILED DESCRIPTION

In general, according to one embodiment, a broadcasting receiving apparatus comprises: a receiver configured to receive distributed moving image data; an acquisition module configured to inform a server configured to store therein content data to be combined with the moving image data of data related to a display size of a screen and acquire the content data according to the display size from the server; a combination module configured to generate display data obtained by combining the acquired contents data with the received moving image data, with a display size based on layout information comprised in the acquired contents data; and an output module configured to perform image processing on the generated display data for being displayed on the screen to output the generated display data on which the image processing is performed, wherein when a ratio of a display area of the moving image data with respect to the screen is a predetermined value or more based on the display size of the moving image data based on the layout information comprised in the acquired content data, the acquisition module informs the server of data related to a display size that is smaller than the display size of the screen and reacquires the content data with a smaller size than the display size of the screen and the combination module generates display data obtained by combining the reacquired contents data with the received moving image data based on the reacquired content data.

Hereinafter, a broadcasting receiving apparatus and method according to an embodiment will be described in detail with reference to the attached drawings.

### First Embodiment

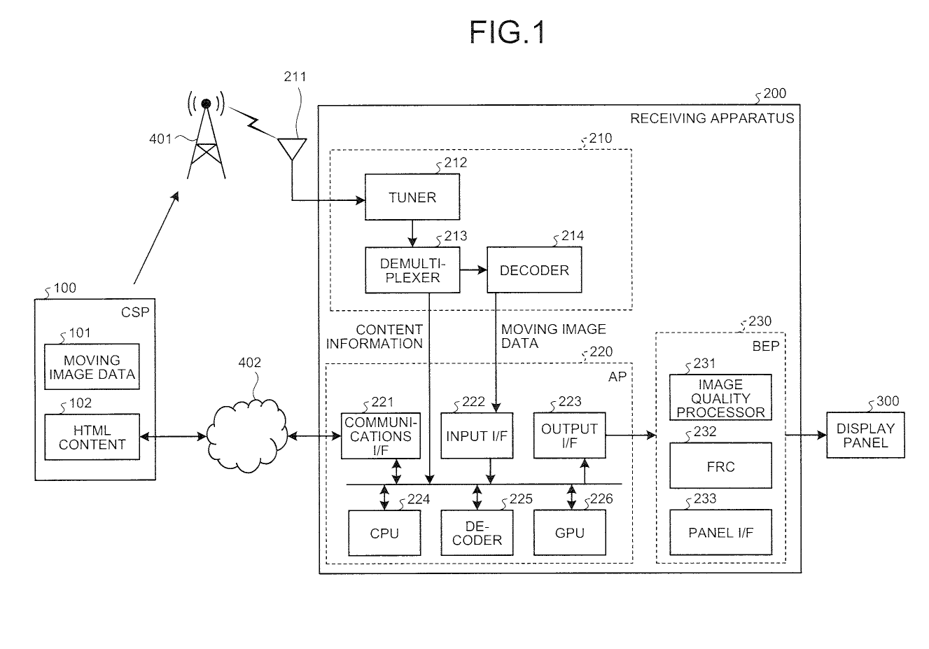

FIG. 1 is a block diagram illustrating the configuration of a receiving apparatus 200 according to a first embodiment.

As illustrated in FIG. 1, the receiving apparatus 200 is a piece of equipment that receives program content such as moving image data 101 that a content service provider (CSP) 100 such as a broadcaster distributes (broadcasts) via a broadcasting antenna 401. Specifically, the receiving apparatus 200 may be a television receiver, HDD recorder, set-top box, or the like. In the present embodiment, the receiving apparatus 200 as a television receiver that performs display on a display panel 300 with 4096×2160 pixels (4K) will be described. The moving image data that the CSP 100 distributes is supposed to have a display size of 2048×1080 pixels (2K) (the size here means the magnitude of the number of pixels).

The CSP 100 not only distributes the moving image data 101 by the broadcasting antenna 401, but also provides a service as a communication-broadcasting integrated service. Specifically, the CSP 100 prepares HTML content 102 for content (a graphic image) that is combined with the moving image data 101 and displayed in a server (not illustrated) and in response to a request from the receiving apparatus 200, transmits the HTML content stored in the server via a communications network 402.

In the HTML content 102, layout information such as the display size, display position, and display contents (text contents or the uniform resource locator (URL) of a still image) of the graphic image such as text and still images that are displayed as various types of screen information and layout information such as the display size and display position of the moving image data 101 are written with tags in the HTML format or the like. By analyzing the layout information written in the HTML content 102, therefore, display data can be generated in which the graphic image and moving image are combined and displayed at a predetermined position.

The receiving apparatus 200 comprises a receiver 210, an AP 220, and a BEP 230. The receiver 210 receives the moving image data 101 that the CSP 100 broadcasts via the broadcasting antenna 401 and separates it into content information and moving image data to be output to the AP 220.

Specifically, the receiver 210 comprises an antenna 211, a tuner 212, a demultiplexer 213, and a decoder 214. The tuner 212 receives the moving image data 101 that is broadcast from the broadcasting antenna 401 via the antenna 211. The demultiplexer 213 separates the received moving image data 101 into the content information related to a moving image and encoded moving image data. The decoder 214 decodes the encoded moving image data. The separated content information and the decoded moving image data are output to the AP 220.

The separated content information may include information indicating the distribution source (the server) of the HTML content 102 (for example, the URL of the server) distributed from the CSP 100 via the communication-broadcasting integrated service. When the information indicating the distribution source of the HTML content 102 is included in the content information, therefore, the HTML content 102 to be combined with the moving image data 101 and displayed can be acquired by requesting the HTML content 102 from the distribution source.

The AP 220 performs general-purpose processing in the receiving apparatus 200. Specifically, the AP 220 comprises a communications I/F 221, an input I/F 222, an output I/F 223, a CPU 224, a decoder 225, and a GPU 226.

The communications I/F 221 performs the transmission and reception of data via the communications network 402. The input I/F 222 receives the inputting of data (the content information and moving image data) from the receiver 210. The output I/F 223 outputs display data (that will be described in detail) to the BEP 230. The central processing unit (CPU) 224 expands a program stored in a read-only memory (ROM) into a random access memory (RAM) to successively run them, thereby centrally controlling the operation of the receiving apparatus 200 (the ROM and RAM are not illustrated). The decoder 225, under the control of the CPU 224, performs decoding on various types of data. The graphics processing unit (GPU) 226, under the control of the CPU 224, performs various types of image processing. Specifically, the GPU 226 performs image processing that combines the graphic image and the moving image data 101 to generate the display data, scaling processing on the graphic image and the moving image data 101 under being combined, or the like.

For example, when the information indicating the distribution source of the HTML content 102 is not included in the content information, because of not being a communication-broadcasting integrated service, the AP 220 outputs the moving image data input from the receiver 210 as it is as the display data to the BEP 230.

When the information indicating the distribution source of the HTML content 102 is included in the content information, because of being a communication-broadcasting integrated service, the AP 220 requests the HTML content 102 from the distribution source of the CSP 100 connected via the communications network 402 to acquire the HTML content 102. Then, the AP 220 analyzes the layout information written with tags in the HTML format or the like in the acquired HTML content 102 and generates the display data for displaying the graphic image and the moving image data input from the receiver 210 on a screen of the display panel 300 with the display size and display position based on the layout information.

The BEP 230 performs image processing on the display data from the AP 220 for displaying it on the screen of the display panel 300. The display data with the image processing performed is output to the display panel 300. Specifically, the BEP 230 comprises an image processor 231, a frame rate converter (FRC) 232, and a panel I/F 233.

The image processor 231 performs image processing according to the display panel 300 on the display data. Specifically, when the display size in the display data from the AP 220 is less than the display size of the display panel 300, scaling processing according to the display size of the display panel 300 is performed. Because in the scaling processing in the image processor 231, unlike scaling processing generally performed by the GPU 226 of the AP 220, pixel interpolation according to the characteristics (brightness or display pitch) of the display panel 300 or pixel interpolation using the super-resolution technique are performed, an image with higher quality than that in the case of the scaling processing by the GPU 226 can be obtained. The image processor 231 improves the image quality of the display data through the conversion of pixel values according to the characteristics (brightness or display pitch) of the display panel 300.

The FRC 232 performs frame rate conversion processing that converts the frame rate of the input display data into a predetermined frame rate. The panel I/F 233 outputs the display data after being subjected to the image processing and the frame rate conversion processing by the image processor 231 and the FRC 232 to the display panel 300.

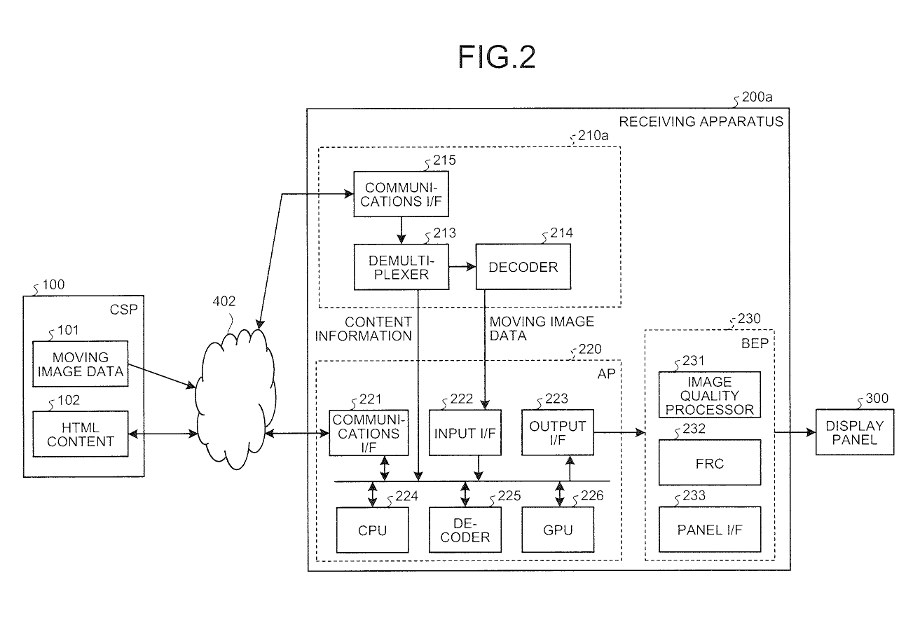

Although the example in FIG. 1 exemplifies a configuration in which the moving image data 101 is distributed by broadcasting via the broadcasting antenna 401, the distribution of the moving image data 101 is not limited to broadcasting. Specifically, as illustrated in FIG. 2, the receiving apparatus may be a receiving apparatus 200a comprising a receiver 210a that receives the moving image data 101 broadcast via the communications network 402. The receiver 210a receives the moving image data 101 broadcast to the communications network 402 via a communications I/F 215 connected to the communications network 402.

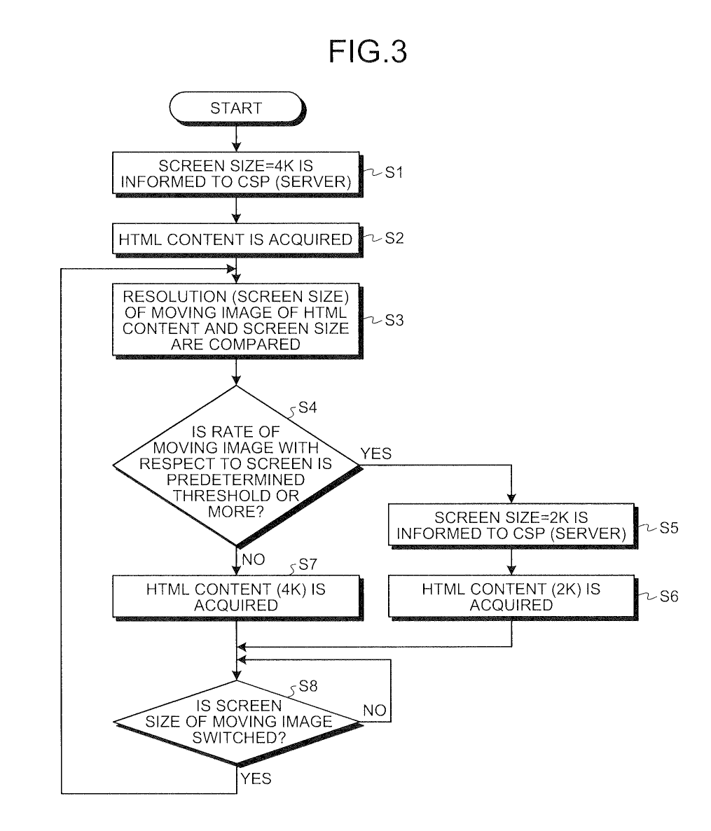

Next, the operation of the receiving apparatuses 200, 200a in the case of a communication-broadcasting integrated service will be described. FIG. 3 is a flowchart illustrating an example of the operation of the receiving apparatus in the first embodiment.

As illustrated in FIG. 3, in the case of a communication-broadcasting integrated service in which the information indicating the distribution source of the HTML content 102 is included in the content information, the AP 220 refers to setting information stored in advance in the ROM or the like, informs the CSP 100 of the screen size (display size) of the display panel 300=4K (S1), and acquires the HTML content 102 according to 4K from the server of the CSP 100 (S2).

Informing of the screen size at S1 is performed by informing the server with information related to the screen size included in the header of an HTTP request. Specifically, information such as “X-video resolution: width=3840; height=2160” is added to the header of the HTTP request. By analyzing this header, the server recognizes the display size (resolution) as 3840×2160, and the HTML content 102 according to the recognized resolution is returned to the receiving apparatuses 200, 200a.

The AP 220 then analyzes the layout information written with tags in the HTML format in the HTML content 102 and compares the resolution (display size) of the moving image on the HTML content 102 with the screen size of the display panel 300 (S3).

For example, suppose that the following tags are included in the HTML content 102.

<p>moving image reproduction by HTML5 video tag</p>
<video controls autoplay poster=“firstframe. jpg” width=“3840” height=“2160”>
<sorce src=“sample.mp4”>
</video>

At S3, by analyzing the above-described tags, it is revealed that the resolution (display size) of the moving image “sample.mp4” is 3840×2160.

Then, based on the comparison result at S3, the AP 220 determines whether the ratio of the display area of the moving image with respect to the screen (screen) of the display panel 300 is a predetermined threshold set in advance as setting information or more (S4).

When the ratio of the display area of the moving image with respect to the screen of the display panel 300 is the predetermined threshold (for example, ¼) or more (Yes at S4), the scaling (upscaling) of the moving image data 101 is required before the moving image data 101 is combined with the 4K HTML content 102 according to the display size of the display panel 300. In the case of Yes at S4, accordingly, the AP 220 informs the CSP 100 of a screen size (display size)=2K, which is smaller than the actual screen size (4K) of the display panel 300 (S5), and reacquires the HTML content 102 according to 2K from the server of the CSP 100 (S6).

Although the present embodiment is an example in which 2K, which does not require the upscaling of the moving image data 101 before being combined, as a screen size that is smaller than the actual screen size (4K) of the display panel 300, the screen size to be informed is not limited to 2K. For example, the screen size to be informed may be one that does not require the upscaling of the moving image data 101 before being combined or one in which the number of pixels interpolated by the general-purpose upscaling in the GPU 226 is small and scaling (upscaling) is performed to the extent that the roughness of image quality is less remarkable.

When the ratio of the display area of the moving image with respect to the screen of the display panel 300 is not the predetermined threshold (for example, ¼) or more (No at S4), the scaling (upscaling) of the moving image data 101 is not required before the 2K moving image data 101 is combined with the 4K HTML content 102 according to the screen size of the display panel 300. For example, when the ratio of the display area of the moving image with respect to the screen is less than ¼, all things to do is down convert . The predetermined threshold may be a value in which the number of pixels interpolated by the general-purpose upscaling in the GPU 226 is small and scaling (upscaling) is performed to the extent that the roughness of image quality is less remarkable. In the case of No at S4, accordingly, the AP 220 reacquires the HTML content 102 according to 4K from the server of the CSP 100 (S7).

The AP 220 generates display data with the graphic image of the HTML content 102 acquired at S6 or S7 and the moving image data 101 combined and outputs it to the BEP 230. The BEP 230 performs the above-described image processing on the display data generated by the AP 220 and outputs it to the display panel 300.

The AP 220 then, based on the layout information of the HTML content 102 or the like, determines the presence or absence of the switching of the display size of the moving image in the moving image data 101 (S8), and waits for the next processing until the switching of the display sized of the moving image is present (Yes at S8). When the switching of the display size of the moving image is present, the AP 220 returns the processing to S3.

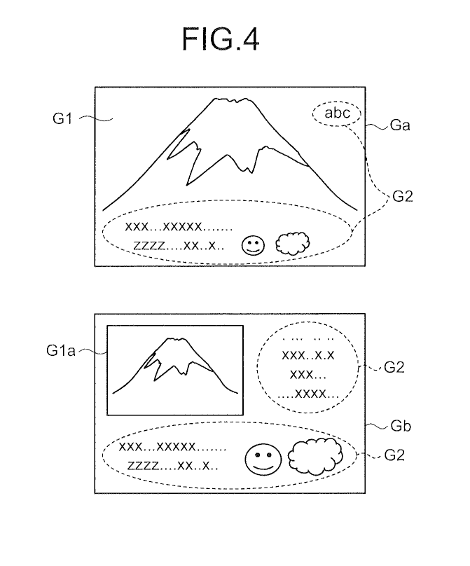

FIG. 4 is a schematic view exemplifying a layout of display data by the HTML content 102. As illustrated in FIG. 4, the layout of a display image Ga combines a moving image G1 in a display area of nearly the entire screen of the HTML content displaying a graphic image G2. The layout of a display image Gb combines a moving image G1a in a display area of nearly ¼ of the HTML content displaying the graphic image G2.

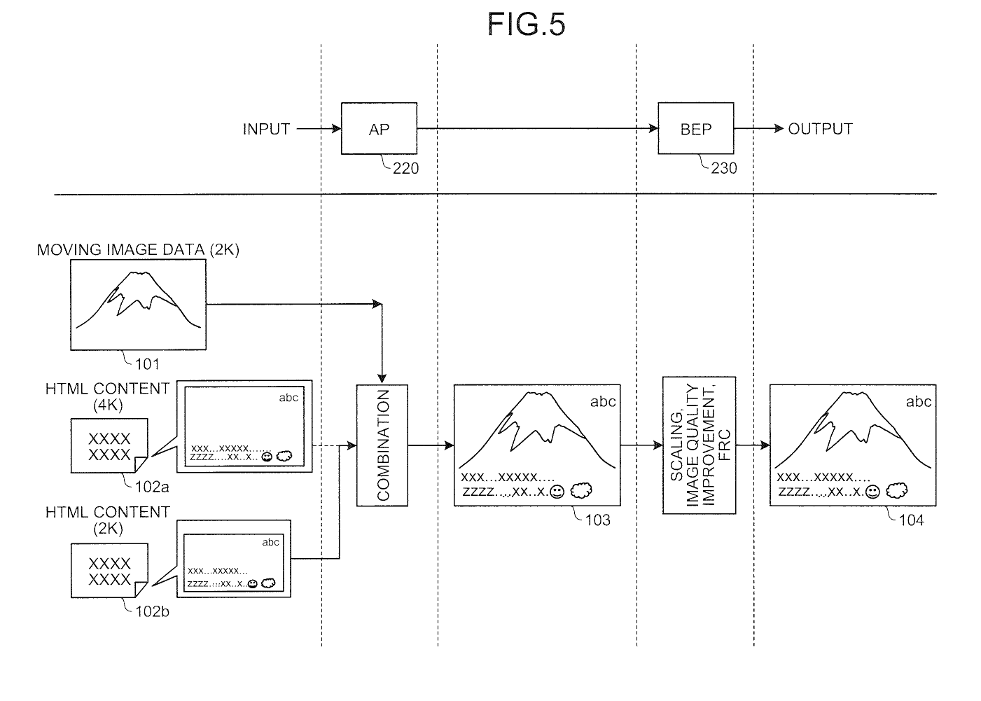

First, operation when the HTML content 102 is the layout of the display image Ga will be described. FIG. 5 is schematic view exemplifying an operational outline of the receiving apparatuses 200, 200a in the first embodiment, and more specifically, a view exemplifying an operational outline when the HTML content 102 is the layout of the display image Ga.

As illustrated in FIG. 5, for the layout displaying the moving image G1 in the display area of nearly the entire screen, HTML content (2K) 102b is reacquired from the server of the CSP 100 at S6. The AP 220 therefore combines the moving image data 101 and a graphic image of the HTML content (2K) 102b, without performing the upscaling of the moving image data 101, thereby allowing 2K display data 103 to be generated. Then, the BEP 230 performs image processing such as scaling, image quality improvement, and FRC on the 2K display data 103 and outputs 4K display data 104 to the display panel 300. Therefore, general-purpose upscaling is not performed on the moving image data 101 on the AP 220 side, but upscaling is performed thereon on the BEP 230 side specializing in the display on the display panel 300. The receiving apparatuses 200, 200a can therefore display higher quality moving images on the display panel 300.

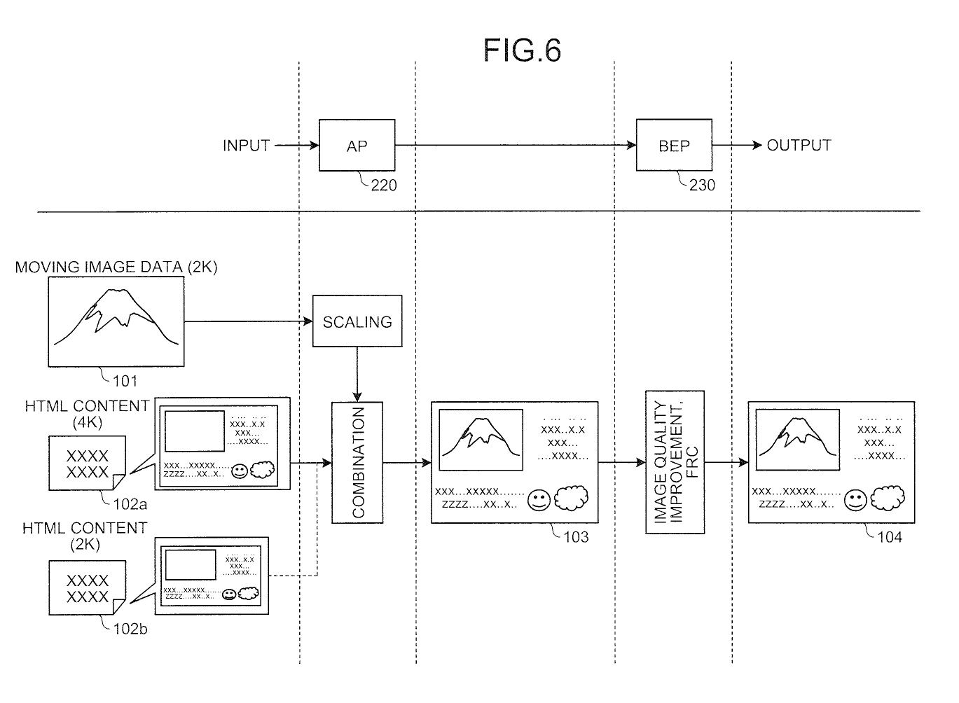

Then, operation when the HTML content 102 is the layout of the display image Gb will be described. FIG. 6 is a schematic view exemplifying an operational outline of the receiving apparatuses 200, 200a in the first embodiment, and more specifically, a view exemplifying an operational outline when the HTML content 102 is the layout of the display image Gb.

As illustrated in FIG. 6, for the layout displaying the moving image G1a in the display area of nearly ¼, HTML content (4K) 102a is reacquired from the server of the CSP 100 at S7. The AP 220 therefore combines the moving image data 101 after performing scaling (downscaling or upscaling to the extent that the roughness of image quality is less remarkable) thereon and the graphic image of the HTML content (4K) 102a, thereby allowing 4K display data 103 to be generated. Then, the BEP 230 performs image processing such as scaling, image quality improvement, and FRC on the 4K display data 103 and outputs the 4K display data 104 to the display panel 300.

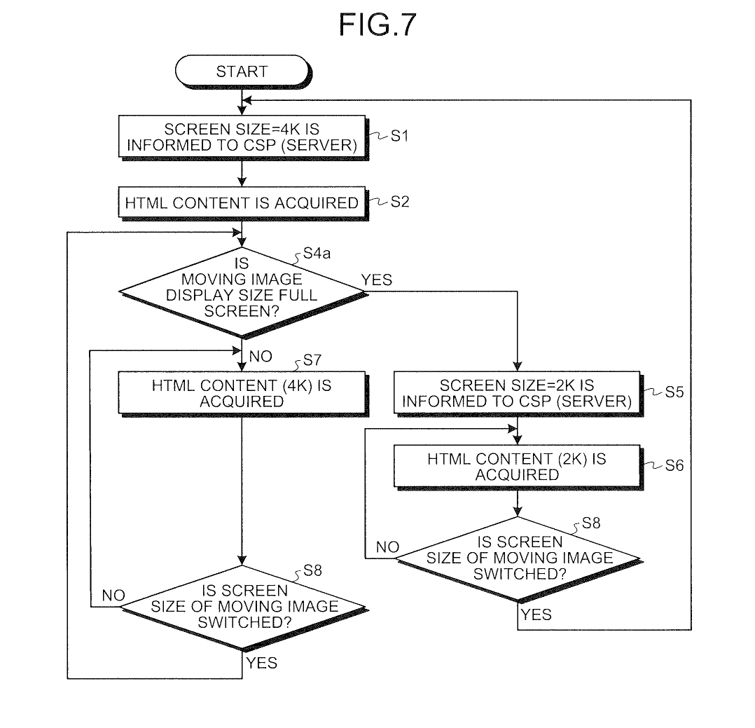

FIG. 7 is a flowchart illustrating a modification of the operation of the receiving apparatuses 200, 200a in the first embodiment. As illustrated in FIG. 7, in this modification, in place of the above-described S4, it is determined whether the display size of the moving image data 101 is the Full (entire) screen display (S4a). When it is the Full (entire) screen display (Yes at S4a), the AP 220 informs the CSP 100 of a size that is smaller than the display size of the display panel 300 (4K), or specifically, a display size that does not require the upscaling of the moving image data 101 before being combined with the graphic image in the AP 220 (for example, 2K) (S5) and acquires the HTML content (2K) 102b (S6).

The AP 220 therefore combines the moving image data 101 and the graphic image of the HTML content (2K) 102b, without performing the upscaling of the moving image data 101, thereby allowing the 2K display data 103 to be generated. Then, the BEP 230 performs image processing such as scaling, image quality improvement, and FRC on the 2K display data 103 and outputs the 4K display data 104 to the display panel 300. Therefore, general-purpose upscaling is not performed on the moving image data 101 on the AP 220 side, but upscaling is performed thereon on the BEP 230 side specializing in the display on the display panel 300. The receiving apparatuses 200, 200a can therefore display higher quality moving images on the display panel 300.

### Second Embodiment

A second embodiment will be described. The second embodiment is different in that not reacquiring the HTML content (2K) 102b when the ratio of the display area of the moving image with respect to the screen of the display panel 300 is a predetermined threshold (for example, ¼) or more (Yes at S4) or when the display size of the moving image data 101 is the Full (entire) screen display (Yes at S4a) as the above-described first embodiment (see FIGS. 3 and 7) and that in the case of YES at S4 and S4a, the HTML content (4K) 102a is downscaled to 2K to be combined with the moving image data 101.

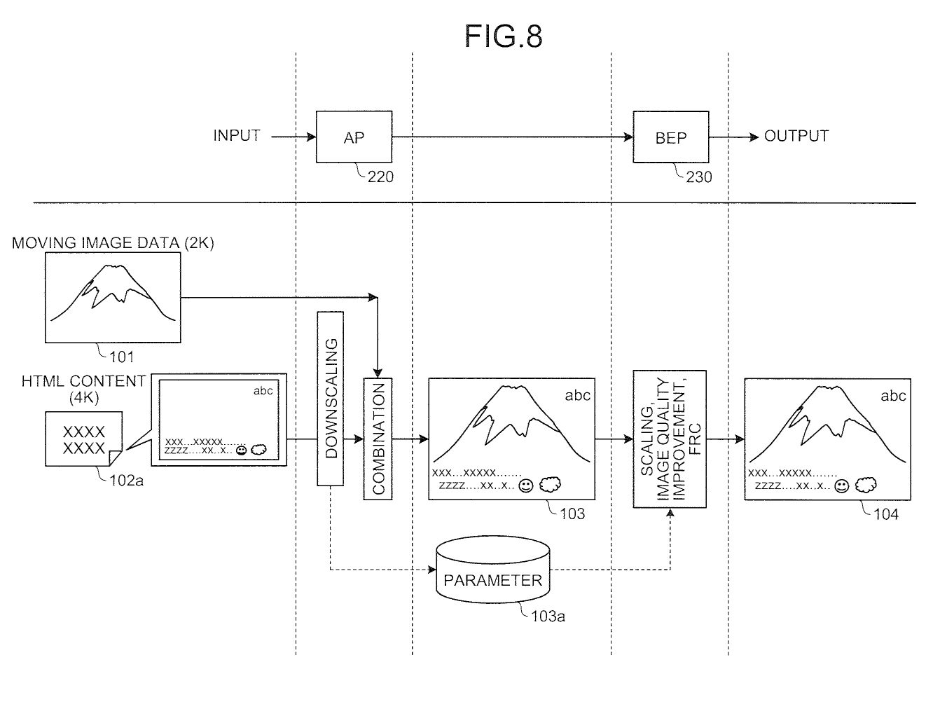

FIG. 8 is a schematic view exemplifying an operational outline of the receiving apparatuses 200, 200a according to the second embodiment. As illustrated in FIG. 8, in the case of YES at S4 and S4a, the AP 220 downscales the graphic image based on the layout information of the HTML content (4K) 102a to 2K. In this downscaling, the AP 220 acquires a parameter 103a related to the downscaling including a parameter related to downscaling, information on an area in which the graphic image is present, or the like and informs the BEP 230 of it. Then, the AP 220 combines the downscaled 2K HTML content (graphic image) and the 2K moving image data 101 to generate the 2K display data 103. In the process, because of the downscaling to the 2K HTML content, the AP 220 combines the 2K moving image data 101 without upscaling it.

Then, the BEP 230 performs image processing such as scaling, image quality improvement, and FRC on the 2K display data 103 and outputs the 4K display data 104 to the display panel 300. Therefore, general-purpose upscaling is not performed on the moving image data 101 on the AP 220 side, but upscaling is performed thereon on the BEP 230 side specializing in the display on the display panel 300. The receiving apparatuses 200, 200a can therefore display higher quality moving images on the display panel 300.

In this scaling (upscaling), the parameter 103a that the AP 220 acquired in the downscaling may be reflected in the scaling processing. Specifically, scaling processing suitable for graphic images such as text and still images is performed based on a parameter related to downscaling, information on an area in which the graphic image is present, or the like included in the parameter 103a. By thus performing upscaling based on the parameter 103a that the AP 220 acquired in the downscaling, the graphic image in the HTML content that was once downscaled to 2K can be restored as a higher quality 4K graphic image.

The above-described first and second embodiments are examples and may be appropriately changed, as long as being configured so that the general-purpose upscaling is not performed on the moving image data 101 on the AP 220 side, but upscaling is performed thereon on the BEP 230 side specializing in the display on the display panel 300. For example, content to be combined with the moving image data 101 is not be limited to HTML content in which layout information is written in the HTML format. The moving image data 101 and the graphic images of the HTML content (4K) 102a and the HTML content (2K) 102b may be transmitted to the BEP 230 independently of each other, and the combination of the moving image data 101 and the graphic images of the HTML content (4K) 102a and the HTML content (2K) 102b may be performed in the BEP 230.

The display size of the display panel 300 is not be limited to 4K, and any size as long as having higher resolution than the display size of the moving image data 101 that is being generally distributed (2K) may be used. For example, it may be quad full high definition (QFHD) (3840×2160 pixels), ultra high definition (7680×4320 pixels), or the like.

A program to be run on the receiving apparatuses 200, 200a of the present embodiments is incorporated into a ROM or the like in advance to be provided. The program to be run on the receiving apparatuses 200, 200a of the present embodiments may be configured to be recorded on a computer-readable recording medium such as a CD-ROM, flexible disk (FD), CD-R, and digital versatile disk (DVD) as a file in an installable form or an executable form.

Furthermore, the program to be run on the receiving apparatuses 200, 200a of the present embodiments maybe configured to be stored on a computer that is connected to a network such as the Internet and to be provided by being downloaded through the network. The program to be run on the receiving apparatuses 200, 200a of the present embodiments may be configured to be provided or distributed through a network such as the Internet.

The program to be run on the receiving apparatuses 200, 200a of the present embodiments is a module configuration including the above-described functional configuration, and as actual hardware, a CPU (processor) reads out the program from the ROM and run it, thereby allowing the above-described functional configuration to be downloaded into a main storage and generated on the main storage.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A broadcasting receiving apparatus comprising:
a receiver configured to receive distributed moving image data;
an acquisition module configured to inform a server configured to store therein content data to be combined with the moving image data of data related to a display size of a screen and acquire the content data according to the display size from the server;
a combination module configured to generate display data obtained by combining the acquired contents data with the received moving image data, with a display size based on layout information comprised in the acquired contents data; and
an output module configured to perform image processing on the generated display data for being displayed on the screen to output the generated display data on which the image processing is performed, wherein
when a ratio of a display area of the moving image data with respect to the screen is a predetermined value or more based on the display size of the moving image data based on the layout information comprised in the acquired content data, the acquisition module informs the server of data related to a display size that is smaller than the display size of the screen and reacquires the content data with a smaller size than the display size of the screen and
the combination module generates display data obtained by combining the reacquired contents data with the received moving image data based on the reacquired content data.

2. The broadcasting receiving apparatus according to claim 1, wherein when a display of the moving image data based on the layout information comprised in the acquired content data is entire screen display, the acquisition module reacquires the content data with a smaller size than the display size of the screen.

3. A broadcasting receiving apparatus comprising:
a receiver configured to receive distributed moving image data;
an acquisition module configured to inform a server configured to store therein content data to be combined with the moving image data of data related to a display size of a screen and acquire the content data according to the display size from the server;
a combination module configured to generate display data obtained by combining the acquired contents data with the received moving image data, with a display size based on layout information comprised in the acquired contents data; and
an output module configured to perform image processing on the generated display data for being displayed on the screen to output the generated display data on which the image processing is performed, wherein
when a ratio of a display area of the moving image data with respect to the screen is a predetermined value or more based on the display size of the moving image data based on the layout information comprised in the acquired content data, the combination module downscales an image based on the acquired content data to generate display data obtained by combining the received moving image data with the downscaled image.

4. The broadcasting receiving apparatus according to claim 3, wherein
the combination module is configured to inform the output module of a parameter related to the downscaling and
the output module is configured to perform scaling processing on the generated display data for being displayed on the screen based on the informed parameter.

5. The broadcasting receiving apparatus according to claim 1, wherein the acquisition module informs the server of a resolution of the screen and acquires the content data according to the resolution from the server.

6. The broadcasting receiving apparatus according to claim 1, wherein in the content data the layout information is written in the HyperText Markup Language (HTML).

7. The broadcasting receiving apparatus according to claim 1, wherein the display size of the screen is any one of QFHD (3840×2160 pixels), 4K (4096×2160 pixels), and ultra high definition (7680×4320 pixels).

8. A method for generating display data with a broadcasting receiving apparatus that comprises:
a receiver configured to receive distributed moving image data;
an acquisition module configured to inform a server configured to store therein content data to be combined with the moving image data of data related to a display size of a screen and acquire the content data according to the display size from the server;
a combination module configured to generate display data obtained by combining the acquired contents data with the received moving image data, with a display size based on layout information comprised in the acquired contents data; and
an output module configured to perform image processing on the generated display data for being displayed on the screen to output the generated display data on which the image processing is performed, the method comprising:
when a ratio of a display area of the moving image data with respect to the screen is a predetermined value or more based on the display size of the moving image data based on the layout information comprised in the acquired content data, informing the server of data related to a display size that is smaller than the display size of the screen and reacquiring the content data with a smaller size than the display size of the screen; and
generating display data obtained by combining the reacquired content data with the received moving image data based on the reacquired content data.
